(19) United States
(12) Patent Application Publication
(10) Pub. No.: US 2011/0133821 A1
(43) Pub. Date: Jun. 9, 2011

(54) CHARGE PUMP CIRCUIT

(75) Inventor: Yuri HONDA, Kanagawa (JP)

(73) Assignee: Renesas Electronics Corporation, Kanagawa (JP)

(21) Appl. No.: 12/960,141

(22) Filed: Dec. 3, 2010

(30) Foreign Application Priority Data
Dec. 4, 2009 (JP) 2009-276856

(51) Int. Cl. G05F 1/10

(52) U.S. Cl. 327/536

(57) ABSTRACT

A charge pump circuit has: first and second charge pump circuits alternately performing boosting operations; and a control circuit. The first (second) charge pump circuit has: plural stages of first (second) switch transistors connected in series; plural stages of first (second) connection nodes respectively connected to sources of the first (second) switch transistors; and plural stages of first (second) capacitors respectively connected to the first (second) connection nodes. The control circuit has: plural stages of first inverters and plural stages of second inverters. The n-th-stage first (second) inverter is supplied with a positive-side power supply voltage from the (n−1)-th-stage second (first) connection node, is supplied with a negative-side power supply voltage from the n-th-stage first (second) connection node, is supplied with an input voltage from the (n−1)-th-stage first (second) connection node, and outputs an output voltage to a gate of the n-th-stage first (second) switch transistor.

### INCORPORATION BY REFERENCE

This application is based upon and claims the benefit of priority from Japanese patent application No. 2009-276856, filed on Dec. 4, 2009, the disclosure of which is incorporated herein in its entirety by reference.

### BACKGROUND OF THE INVENTION

1. Field of the Invention

The present invention relates to a charge pump circuit.

2. Description of Related Art

An electronic device operating by a low-voltage power supply such as a battery cell generally uses a booster circuit that boosts the low power supply voltage up to an operation voltage with which the electronic device can operate normally.

One representative booster circuit is a charge pump-type booster circuit (hereinafter referred to as a charge pump circuit) that is configured by combining a plurality of diodes and a plurality of capacitors. The charge pump circuit is preferably used in a semiconductor integrated circuit.

In the charge pump circuit, a pair of a diode and a capacitor is arranged for a number of stages depending on a desired output voltage. The first-stage capacitor is charged by the power supply voltage, the second-stage capacitor is charged by the charges of the first-stage capacitor, and the third-stage capacitor is charged by the charges of the second-stage capacitor. The charging is repeated in this manner until the final-stage. Consequently, the input voltage is increased to a desired output voltage. An operating principle of a typical charge pump circuit will be described below with reference to FIG. 1.

FIG. 1 shows a configuration of a charge pump circuit in which a pair of a diode and a capacitor is arranged for five stages. Specifically, the charge pump circuit shown in FIG. 1 has: five diodes D1 to D5 that are connected in series; and five capacitors C1 to C5 that are respectively connected to connection nodes a1 to a5 of the diodes D1 to D5. One ends of the capacitors C1 and C3 are respectively connected to the connection nodes a1 and a3, and the other ends thereof are supplied with a control signal S1. One ends of the capacitors C2 and C4 are respectively connected to the connection nodes a2 and a4, and the other ends thereof are supplied with a control signal S2.

Here, a level of the control signals S1 and S2 each is switched between 0 V and Vdd with a predetermined period. Moreover, the control signals S1 and S2 are different from each other in the 0 V period and the Vdd period. That is, the control signals S1 and S2 are a complementary signal.

When the level of the control signal S1 is 0 V (the level of the control signal S2 is Vdd), the capacitor C1 is charged by an input power supply voltage Vdd through the diode D1. The charge voltage at this time is “Vdd−VF”, wherein VF is a forward voltage drop of the diode.

Next, when the level of the control signal S1 becomes Vdd (the level of the control signal S2 becomes 0 V), the voltage of the connection node a1 of the capacitor C1 becomes “2Vdd−VF”. At this time, the level of the control signal S2 is 0 V, and thus the capacitor C2 is charged to “2Vdd−2VF” through the diode D2. The charging is repeated in this manner, and the charge voltages of the other capacitors C3, C4 and C5 also are increased. As a result, the charge pump circuit shown in FIG. 1 can generate the output voltage of about “5Vdd−5VF”.

In the case of the charge pump circuit shown in FIG. 1, the output voltage is decreased from “5Vdd” by “5VF” that is a sum of the forward voltage drops by the diodes D1 to D5. That is, the output voltage is decreased due to the voltage drop of the control element (diode) that controls the charging to the capacitor. It is therefore considered to use an element with a small voltage drop amount as the control element of the charging operation, in order to increase the output voltage of the charge pump circuit. For example, the diode is replaced with a FET (Field Effect Transistor; hereinafter referred to simply as a transistor), and thereby the decrease in the output voltage can be greatly suppressed.

FIG. 2 shows a configuration of a charge pump circuit that uses the transistor instead of the diode. The charge pump circuit shown in FIG. 2 is a negative voltage booster circuit. The charge pump circuit shown in FIG. 2 has: transistors FET1 to FET6 whose sources and drains are connected in series; and capacitors C11 to C15 whose one ends are respectively connected to connection nodes a11 to a15 between the transistors FET1 to FET6. One ends of the capacitors C11, C13 and C15 are respectively connected to the connection nodes a11, a13 and a15, and the other ends thereof are supplied with a control signal S3. One ends of the capacitors C12 and C14 are respectively connected to the connection nodes a12 and a14, and the other ends thereof are supplied with a control signal S4.

As shown in FIG. 3, a level of the control signals S3 and S4 each is switched between 0 V and VDD with a predetermined period. Moreover, the control signals S3 and S4 are different from each other in the 0 V period and the VDD period. Furthermore, there exists a period in which the levels of both of the control signals S3 and S4 are 0 V. For example, the control signals S3 and S4 both are at 0 V in a period T1. In a period T2, the control signal S3 is maintained at 0 V while the control signal S4 is switched to VDD. In a period T3, the control signals S3 and S4 both are at 0 V. In a period T4, the control signal S3 is switched to VDD while the control signal S4 is maintained at 0 V. In a period T5, the control signals S3 and S4 both are at 0 V. In a period T6, the control signal S3 is maintained at 0 V while the control signal S4 is switched to VDD.

Control signals G1 to G6 are supplied to gates of the transistors FET1 to FET6, respectively. That is, the transistors FET1 to FET6 are ON/OFF controlled by the control signals G1 to G6, respectively. In the present example, the transistors FET1, FET3 and FET5 are turned ON and the transistors FET2 and FET4 are turned OFF when the control signal S3 is at VDD. On the other hand, the transistors FET1, FET3 and FET5 are turned OFF and the transistors FET2 and FET4 are turned ON when the control signal S4 is at VDD.

An operation of the charge pump will be described with reference to FIGS. 2 and 3. When the control signal S3 is at VDD, the capacitor C11 is charged by the power supply voltage VDD through the transistor FET1. Here, let us consider a case where a voltage drop between a drain and a source of the transistor is 0 V. In this case, the charge voltage of the capacitor C11 is “VDD”.

Next, the control signal S3 is switched to 0 V, and the transistor FET1 is switched from ON to OFF. As a result, a voltage of the connection node a11 of the capacitor C11 becomes “−VDD”. Since the transistor FET2 is in the OFF state at the time when the transistor FET1 is switched from ON to OFF, no current flows from the connection node a12 to the connection node a11. Next, the transistor FET2 is turned ON, and the control signal S4 is switched to VDD. As a result, the capacitor C12 is charged with “2VDD” through the transistor FET2.

Next, the control signal S4 is switched to 0 V, and the transistor FET2 is switched from ON to OFF. As a result, a voltage of the connection node a12 of the capacitor C12 becomes “−2VDD”. Since the transistor FET3 is in the OFF state at the time when the transistor FET2 is switched from ON to OFF, no current flows from the connection node a13 to the connection node a12. Next, the transistor FET3 is turned ON, and the control signal S3 is switched to VDD. As a result, the capacitor C13 is charged with “3VDD” through the transistor FET3.

The same applies to the other capacitors. Consequently, the output voltage of “−5VDD” can be obtained. In the case of the charge pump circuit shown in FIG. 2, there exists the period in which the FET switches are turned OFF concurrently, which can suppress the above-mentioned boosting loss caused by the voltage drop.

Here, let us look at the control signals G1 to G5 used for ON/OFF controlling the transistor. In a case of an N-channel MOS (Metal Oxide Semiconductor) FET, the transistor is turned ON when a gate-source voltage becomes higher than its threshold voltage Vt and is turned OFF when the gate-source voltage becomes lower than the threshold voltage Vt. As shown in FIG. 2, the source and back gate of the transistor FET1 are connected to the connection node a11. In the period T4 when the control signal S3 is at VDD, the voltage of the connection node a11 is 0V, and thus the level of the control signal G1 is required to be higher than “0V+Vt” for turning ON the transistor FET1.

In the period T5 when both of the control signals S3 and S4 are at 0 V, the voltage of the connection node a11 is −VDD, and thus the level of the control signal G1 is required to be lower than “−VDD+Vt” for turning OFF the transistor FET1. Similarly, in the period T6 when the control signal S3 is at 0 V, the voltage of the connection node a11 is −VDD, and thus the level of the control signal G1 is required to be lower than “−VDD+Vt” for turning OFF the transistor FET1.

The source and back gate of the transistor FET2 are connected to the connection node a12. In the period T4 when the control signal S3 is at VDD, the voltage of the connection node a12 is −2VDD, and thus the level of the control signal G2 is required to be lower than “−2VDD+Vt” for turning OFF the transistor FET2. In the periods T5 and T6 when the control signal S3 is at 0 V, the voltage of the connection node a12 is −VDD, and thus the level of the control signal G2 is required to be higher than “−VDD+Vt” for turning ON the transistor FET2.

Similarly, the level of the control signal G3 is required to be higher than “−2VDD+Vt” for turning ON the transistor FET3 and to be lower than “−3VDD+Vt” for turning OFF the transistor FET3. The level of the control signal G4 is required to be higher than “−3VDD+Vt” for turning ON the transistor FET4 and to be lower than “−4VDD+Vt” for turning OFF the transistor FET4. The level of the control signal G5 is required to be higher than “−4VDD+Vt” for turning ON the transistor FET5 and to be lower than “−5VDD+Vt” for turning OFF the transistor FET5.

Let us consider the control signal G3 as an example. In order to turn ON the transistor FET3, the level of the control signal G3 is required to be higher than “−2VDD+Vt” as described above. However, in the example shown in FIG. 3, the control signal G3 of the voltage VDD (High level) is used for turning ON the transistor FET3. In this case, “3VDD” as a voltage difference between the gate voltage (control signal G3) and the source voltage (the voltage of the connection node a13) is applied to the transistor FET3. Therefore, a breakdown voltage of higher than “3VDD” is necessary for the transistor FET3. Similarly, a breakdown voltage of higher than “4VDD” is necessary for the transistor FET4. In general, an element with a higher breakdown voltage has lower current drivability and a larger layout size. It is therefore desirable to set the gate control voltage so as not to increase the breakdown voltage of the transistor.

Japanese Patent Publication JP-2009-011121 (Patent Document 1) describes a charge pump circuit having a circuit that generates the gate control signal depending on the breakdown voltage of the transistor. FIG. 4 shows a configuration of an inverting-type charge pump circuit 100 generating a negative voltage, which is described in the Patent Document 1. In the charge pump circuit 100, switches SW101 to SW104 each consists of a MOS transistor, and a control circuit 105 ON/OFF controls the switches SW101 to SW104 through driver circuits 101 to 104, respectively.

First, the control circuit 105 turns ON the switches SW101 and SW102 to be electrical-connection state while turns OFF the switches SW103 and SW104 to be cut-off state. As a result, a capacitor C101 is charged with a voltage (Vin−Vc). Next, the control circuit 105 turns OFF the switches SW101 and SW102 to be cut-off state while turns ON the switches SW103 and SW104 to be electrical-connection state. As a result, a capacitor 102 is charged with an inverted voltage of the voltage charged in the capacitor C101, and the inverted voltage is output as a negative output voltage Vout. In a case of no load, the output voltage Vout is equal to “−(Vin−Vc)”.

The driver circuits 101 to 104 shift voltage levels of control signals input from the control circuit 105 to generate the respective gate control signals supplied to the switches SW101 to 104.

However, in the case of the circuit shown in FIG. 4, the negative voltage “−(Vin−Vc)” is applied to a node CN. Here, the power supply voltage of the driver circuits 102 and 104 is the input voltage Vin. Therefore, a voltage difference of up to (2×Vin−Vc) is applied to each gate of the switches SW102 and SW104 and the node CN. In order to make the voltage difference smaller than the breakdown voltage of the MOS transistor (switch), it is necessary to increase the breakdown voltage of the MOS transistor (switch) or to prevent occurrence of such the voltage difference by using a complicated voltage control method.

The Patent Document 1 also describes an inverting-type charge pump circuit 110 for solving the problem. The charge pump circuit 110 is obtained by adding a simple circuit to the circuit shown in FIG. 4.

FIG. 5 shows a configuration of the charge pump circuit 110 described in the Patent Document 1. The charge pump circuit 110 receives the input voltage Vin through an input terminal IN, generates a predetermined negative voltage from the input voltage Vin, and outputs the negative voltage as the output voltage Vout from an output terminal OUT.

As shown in FIG. 5, an NMOS transistor M110 is inserted between a switch SW111 and a node CP in the charge pump circuit 110. A constant voltage Vb is supplied to a gate of the NMOS transistor M110. It is possible to reduce ripple of the output voltage Vout without increasing the breakdown voltages of MOS transistors functioning as switches SW111 to SW114.

When the switches SW111 and SW112 are turned ON, a maximum voltage difference (Vb−Vc) is applied to the switch SW112. On the other hand, when the switches SW113 and SW114 are turned ON, a maximum voltage difference (2×Vb−Vc) is applied to the switch SW114.

In the case of the charge pump circuit 110, the voltage applied to the MOS transistor (switches SW111 to SW114) can be made smaller than the breakdown voltage of the MOS transistor by appropriately setting the constant voltage Vb. However, a constant-voltage circuit for supplying the constant voltage Vb causes increase in a circuit size of the charge pump circuit 110. Moreover, it is necessary to set the constant voltage Vb such that the voltage difference (2×Vb−Vc) becomes smaller than the breakdown voltage of the switch SW114. The lowest voltage which can be output as the output voltage Vout is “−(Vb−Vc)”.

Here, let us consider a case where the voltage Vc is equal to 0 V. In this case, the lowest output voltage Vout is “−Vb”. The maximum voltage difference applied to the switch SW114 is “2×Vb”, and thus the breakdown voltage of the switch SW114 is set to about “2×Vb”. Therefore, the lowest output voltage Vout of the charge pump circuit 110 is at most half the breakdown voltage of the switch SW114. If the voltage Vc is set to a negative voltage, the lowest output voltage Vout can be made lower. However, a voltage difference between the input voltage Vin and the voltage Vc needs to be smaller than the breakdown voltage of the switch SW113. Thus, an absolute value of the output voltage Vout cannot exceed the element breakdown voltage of the switch SW113.

Japanese Patent Publication JP-2005-204366 (Patent Document 2) describes another example that controls the gate control voltage for the switch FET within the breakdown voltage. The Patent Document 2 describes a circuit that controls the gate control voltage to a maximum value of the breakdown voltage of the switch FET.

Japanese Patent Publication JP-2001-086735 (Patent Document 3) describes a booster circuit that can suppress variation in the output voltage. Specifically, when one of two clamp capacitors is series-connected to power supply, the other thereof is parallely-connected to the power supply.
[Patent Document 1] Japanese Patent Publication JP-2009-011121
[Patent Document 2] Japanese Patent Publication JP-2005-204366
[Patent Document 3] Japanese Patent Publication JP-2001-086735

### SUMMARY

The inventor of the present application has recognized the following points.

According to the technique described in the Patent Document 2, it is possible to control the gate control signal input to the switch FET to be the maximum breakdown voltage of the transistor. It is thus possible to reduce the breakdown voltage of the switch FET and to reduce the circuit size. However, a circuit for controlling the gate control signal requires a high-voltage element, which results in increase in the circuit size. Moreover, it is necessary to supply a constant current for controlling the gate control signal, which results in reduction in a boosting efficiency.

Furthermore, according to the technique described in the Patent Document 2, the absolute value of the output voltage cannot be made larger than the breakdown voltage of the transistor, as in the case of the Patent Document 1. The same applies to the technique described in the Patent Document 3.

As described above, although various circuits that generate the gate control voltage have been proposed for reducing the breakdown voltage of the switch FET, the charge pump output is limited to smaller than the element breakdown voltage, which is a problem.

In an aspect of the present invention, a charge pump circuit has: a first charge pump circuit and a second charge pump circuit that alternately perform boosting operations; and a control circuit configured to control the respective boosting operations of the first charge pump circuit and the second charge pump circuit. The first charge pump circuit has: plural stages of first switch transistors that are series-connected one after another; plural stages of first connection nodes that are respectively connected to sources of the plural stages of first switch transistors; and plural stages of first capacitors whose one ends are respectively connected to the plural stages of first connection nodes. The second charge pump circuit has: plural stages of second switch transistors that are series-connected one after another; plural stages of second connection nodes that are respectively connected to sources of the plural stages of second switch transistors; and plural stages of second capacitors whose one ends are respectively connected to the plural stages of second connection nodes. The control circuit has: plural stages of first inverters; and plural stages of second inverters.

Here, n is an integer equal to or more than 3. The n-th-stage first inverter of the plural stages of first inverters is configured to be supplied with a positive-side power supply voltage from the (n−1)-th-stage second connection node of the plural stages of second connection nodes, to be supplied with a negative-side power supply voltage from the n-th-stage first connection node of the plural stages of first connection nodes, to be supplied with an input voltage from the (n−1)-th-stage first connection node of the plural stages of first connection nodes, and to output an output voltage to a gate of the n-th-stage first switch transistor of the plural stages of first switch transistors. The n-th-stage second inverter of the plural stages of second inverters is configured to be supplied with a positive-side power supply voltage from the (n−1)-th-stage first connection node of the plural stages of first connection nodes, to be supplied with a negative-side power supply voltage from the n-th-stage second connection node of the plural stages of second connection nodes, to be supplied with an input voltage from the (n−1)-th-stage second connection node of the plural stages of second connection nodes, and to output an output voltage to a gate of the n-th-stage second switch transistor of the plural stages of second switch transistors.

As described above, the first charge pump circuit and the second charge pump circuit alternately perform the boosting operations. A charging state of the capacitor of one of the first and second charge pump circuits is used for controlling the charging of the capacitor of the other thereof in the next period. The voltage applied to the switch is always less than the breakdown voltage of the switch, even if the number of stages of the capacitors and switch transistors is increased. It is therefore possible to make the charge pump output voltage larger than the element breakdown voltage, by increasing the number of stages of the capacitors and switch transistors.

The charge pump circuit according to the present invention can output the boosted voltage whose absolute value is larger than the element breakdown voltage of the transistor. Moreover, the boosting operation is possible by the gate control voltage smaller than the element breakdown voltage of the transistor. Furthermore, the element breakdown voltage of the switch transistor can be reduced. Furthermore, the circuit size of the charge pump circuit can be reduced.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a configuration of a typical charge pump circuit provided with diodes and capacitors;

FIG. 2 shows a configuration of a typical charge pump circuit using transistors;

FIG. 3 is a timing chart showing an operation of the charge pump circuit shown in FIG. 2;

FIG. 4 shows a configuration of a conventional charge pump circuit described in the Patent Document 1 (Japanese Patent Publication JP-2009-011121);

FIG. 5 shows a configuration of another conventional charge pump circuit described in the Patent Document 1 (Japanese Patent Publication JP-2009-011121);

FIG. 6 shows a configuration of a charge pump circuit according to an embodiment of the present invention;

FIG. 7 shows a configuration of an example of a level shift circuit according to the embodiment of the present invention;

FIG. 8A is a timing chart showing an operation (step down operation) of the charge pump circuit according to the embodiment of the present invention;

FIG. 8B is a timing chart showing an operation (step down operation) of the charge pump circuit according to the embodiment of the present invention; and

FIG. 9 shows another configuration of a charge pump circuit according to the embodiment of the present invention.

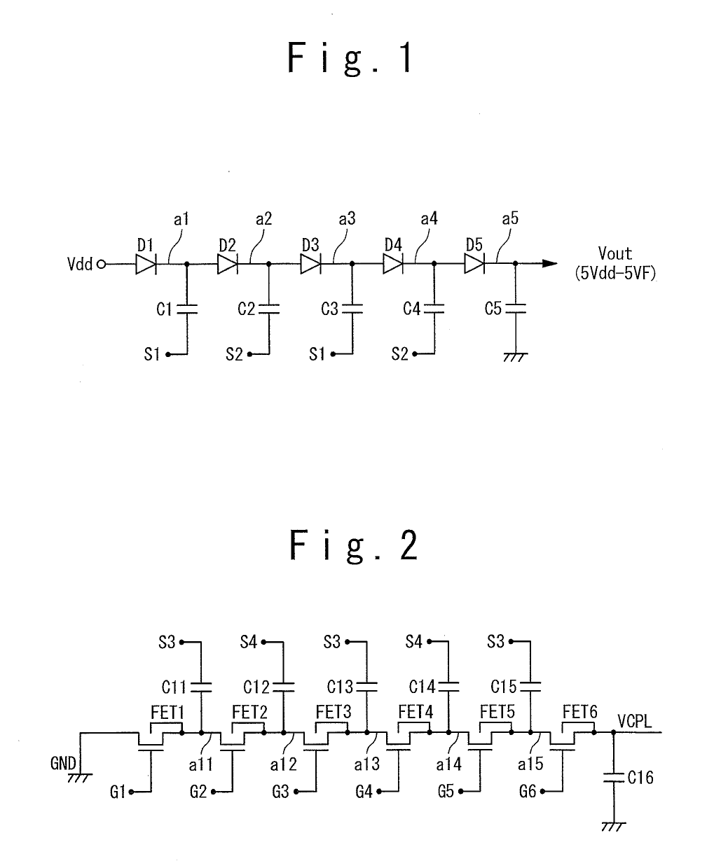

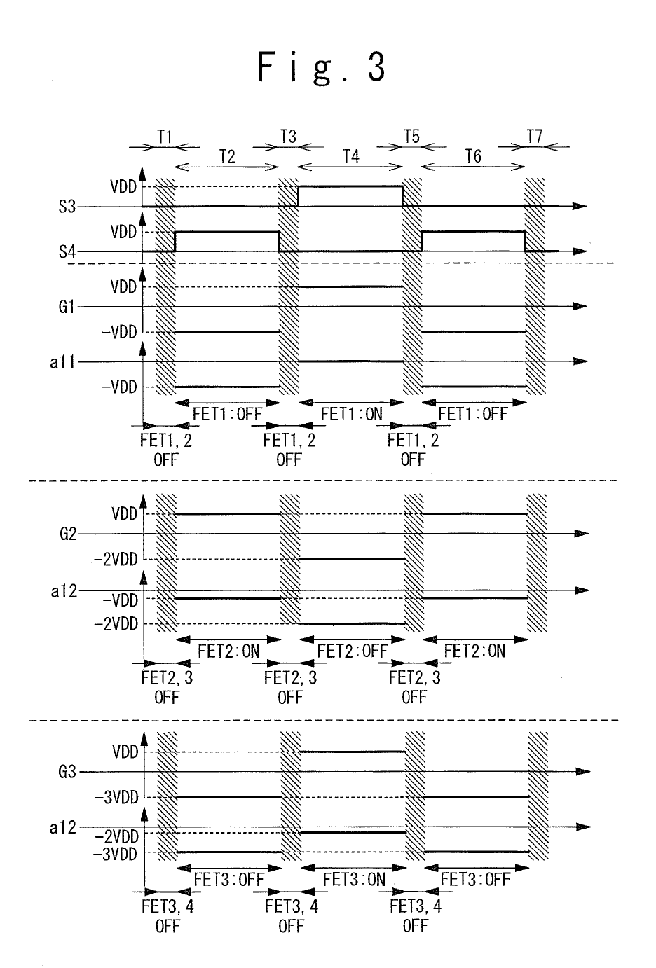

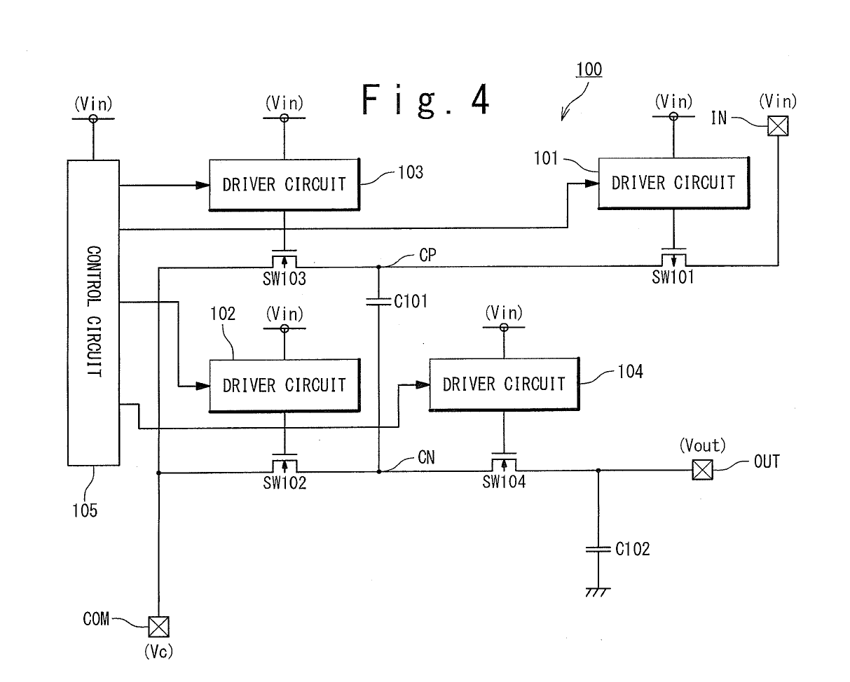

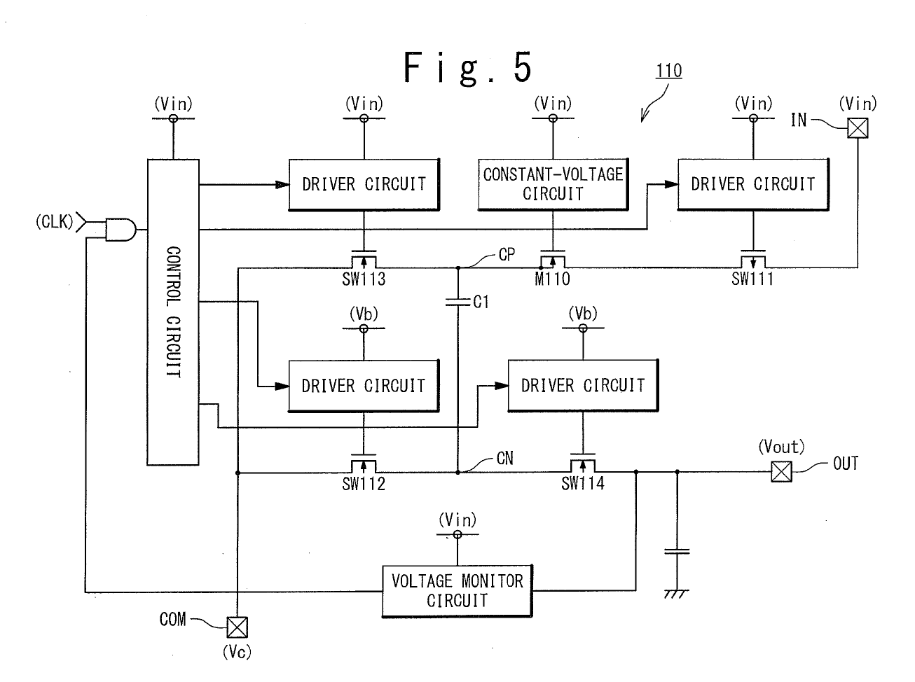

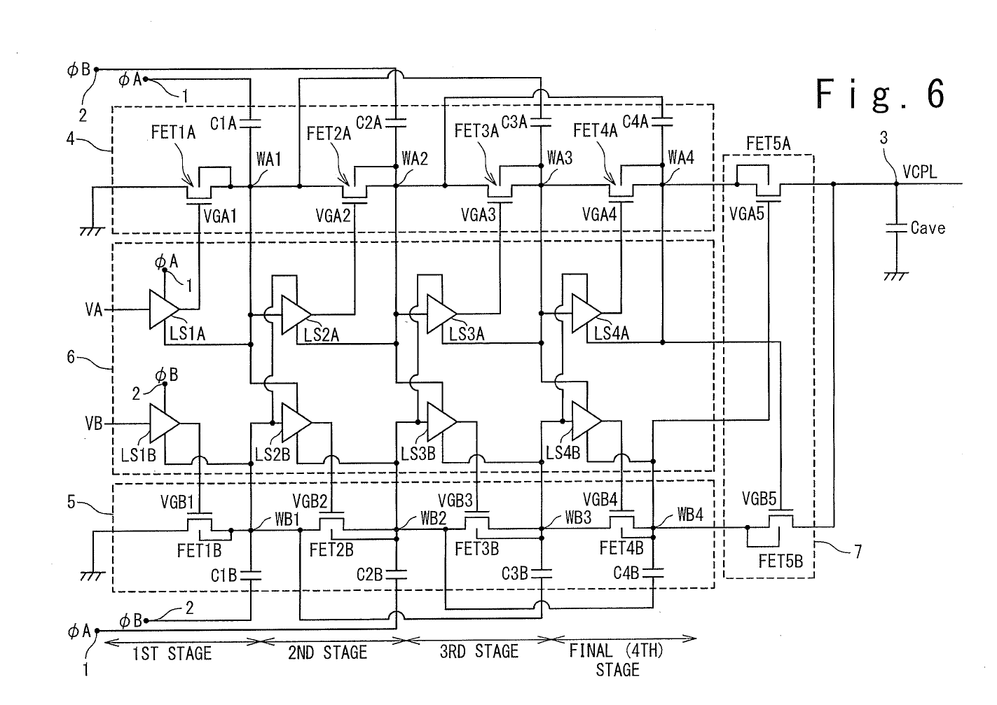

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

(Configuration)

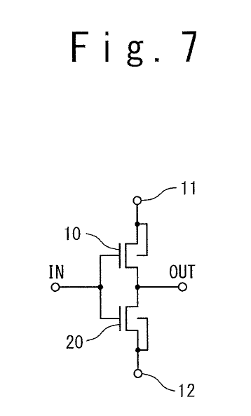

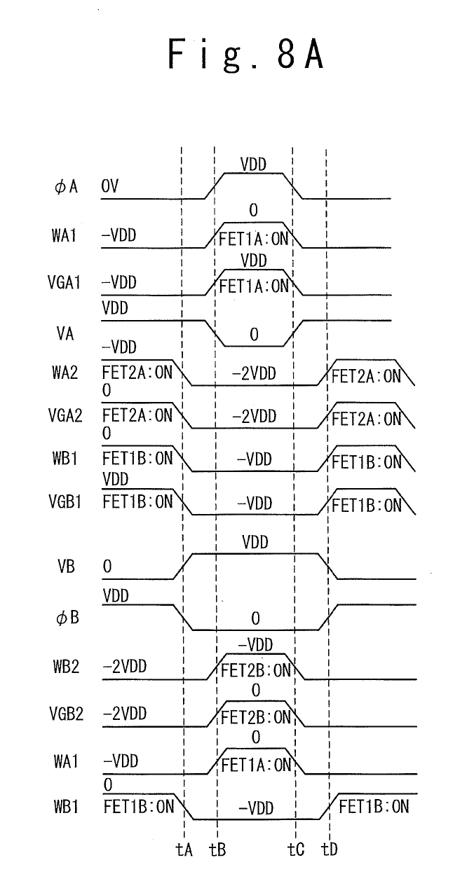

A configuration of a charge pump circuit according to an embodiment of the present invention will be described with reference to FIG. 6 and FIG. 7. FIG. 6 shows the configuration of the charge pump circuit according to the embodiment of the present invention. A four-stage negative voltage booster circuit will be described as an example of the charge pump circuit according to the embodiment of the present invention.

The charge pump circuit according to the embodiment of the present invention has: plural stages of first switches (FET1A, FET2A, FET3A and FET4A); plural stages of second switches (FET1B, FET2B, FET3B and FET4B); a third switch FET5A; a fourth switch FET5B; plural stages of first connection nodes (WA1, WA2, WA3 and WA4); plural stages of first capacitors (C1A, C2A, C3A and C4A); plural stages of second connection nodes (WB1, WB2, WB3 and WB4); plural stages of second capacitors (C1B, C2B, C3B and C4B); a smoothing capacitor Cave; plural stages of first level shift circuits (LS1A, LS2A, LS3A and LS4A); and plural stages of second level shift circuits (LS1B, LS2B, LS3B and LS4B).

A transistor (ex: FET) which generates a small voltage drop when turned ON is preferably used as each of the switches: the first switches FET1A to FET4A, the second switches FET1B to FET4B, the third switch FET5A and the fourth switch FET5B.

The first capacitors C1A to C4A and the second capacitors C1B to C4B each is a booster capacitor. The first switches FET1A to FET4A are switch elements for controlling charging to the respective first capacitors C1A to C4A. A circuit including the first capacitors C1A to C4A, the first switches FET1A to FET4A and the connection nodes WA1 to WA4 is hereinafter referred to as a “first charge pump circuit 4”. The second switches FET1B to FET4B are switch elements for controlling charging to the respective second capacitors C1B to C4B. A circuit including the second capacitors C1B to C4B, the second switches FET1B to FET4B and the connection nodes WB1 to WB4 is hereinafter referred to as a “second charge pump circuit 5”. The first charge pump circuit 4 and the second charge pump circuit 5 alternately perform the boosting operations.

Sources and drains of the first switches FET1A to FET4A and the third switch FET5A are series-connected one after another. The connection nodes WA1 to WA4 are respectively connected to the sources of the first switches FET1A to FET4A. One ends of the capacitors C1A to C4A are respectively connected to the connection nodes WA1 to WA4. Thus, the first charge pump circuit 4 shown in FIG. 6 is constituted by four-stage charge circuits.

The first switch FET1A and the capacitor C1A form the first-stage charge circuit in the first charge pump circuit 4. A drain and a source of the first switch FET1A are respectively connected to a GND terminal (0V) and the connection node WA1. The capacitor C1A is connected between the connection node WA1 and an input terminal 1 (first input terminal) to which an input signal φA (first input signal) is supplied. The first switch FET2A and the capacitor C2A form the second-stage charge circuit in the first charge pump circuit 4. A drain and a source of the first switch FET2A are respectively connected to the connection node WA1 and the connection node WA2. The capacitor C2A is connected between the connection node WA2 and an input terminal 2 (second input terminal) to which an input signal φB (second input signal) is supplied. The first switch FET3A and the capacitor C3A form the third-stage charge circuit in the first charge pump circuit 4. A drain and a source of the first switch FET3A are respectively connected to the connection node WA2 and the connection node WA3. The capacitor C3A is connected between the connection node WA3 and the connection node WA1 to which an output voltage of the first-stage is supplied. The first switch FET4A and the capacitor C4A form the fourth-stage charge circuit in the first charge pump circuit 4. A drain and a source of the first switch FET4A are respectively connected to the connection node WA3 and the connection node WA4. The capacitor C4A is connected between the connection node WA4 and the connection node WA2 to which an output voltage of the second-stage is supplied.

It should be noted that a level of each of the input signals φA and φB is switched between the High level and the Low level with a predetermined period. The input signals φA and φB alternately take the High level. That is, the input signal φA is at the Low level when the input signal φB is at the High level. Similarly, the input signal φB is at the Low level when the input signal φA is at the High level. There may be a period when both of the input signals φA and φB are at the Low level.

The sources/back gates of the first switches FET1A to FET4A are respectively connected to the connection nodes WA1 to WA4 (i.e. output terminals of the respective stages).

Sources and drains of the second switches FET1B to FET4B and the fourth switch FET5B are series-connected one after another. The connection nodes WB1 to WB4 are respectively connected to the sources of the second switches FET1B to FET4B. One ends of the capacitors C1B to C4B are respectively connected to the connection nodes WB1 to WB4. Thus, the second charge pump circuit 5 shown in FIG. 6 is constituted by four-stage charge circuits.

The second switch FET1B and the capacitor C1B form the first-stage charge circuit in the second charge pump circuit 5. A drain and a source of the second switch FET1B are respectively connected to the GND terminal (0V) and the connection node WB1. The capacitor C1B is connected between the connection node WB1 and the input terminal 2 (second input terminal) to which the input signal φB (second input signal) is supplied. The second switch FET2B and the capacitor C2B form the second-stage charge circuit in the second charge pump circuit 5. A drain and a source of the second switch FET2B are respectively connected to the connection node WB1 and the connection node WB2. The capacitor C2B is connected between the connection node WB2 and the input terminal 1 (first input terminal) to which the input signal φA (first input signal) is supplied. The second switch FET3B and the capacitor C3B form the third-stage charge circuit in the second charge pump circuit 5. A drain and a source of the second switch FET3B are respectively connected to the connection node WB2 and the connection node WB3. The capacitor C3B is connected between the connection node WB3 and the connection node WB1 to which an output voltage of the first-stage is supplied. The second switch FET4B and the capacitor C4B form the fourth-stage charge circuit in the second charge pump circuit 5. A drain and a source of the second switch FET4B are respectively connected to the connection node WB3 and the connection node WB4. The capacitor C4B is connected between the connection node WB4 and the connection node WB2 to which an output voltage of the second-stage is supplied.

The sources/back gates of the second switches FET1B to FET4B are respectively connected to the connection nodes WB1 to WB4 (i.e. output terminals of the respective stages).

With regard to the n-th-stage capacitor (here, n is an integer equal to or more than 3) in each charge pump circuit, one end thereof is connected to the n-th-stage connection node (the output terminal of the n-th-stage) while the other end thereof is connected to the former-stage connection node that is simultaneously charged. In the present embodiment, the even-numbered stages are simultaneously charged, and the odd-numbered stages are simultaneously charged. Therefore, the one end of the n-th-stage capacitor is connected to the n-th-stage connection node (the output terminal of the n-th-stage) while the other end thereof is connected to the (n−2)-th-stage connection node (the output terminal of the (n−2)-th-stage).

The third switch FET5A and the fourth switch FET5B form an output control circuit 7 that selects one of outputs of the first charge pump circuit 4 and the second charge pump circuit 5 and outputs the selected one to an output terminal 3. More specifically, a source, a drain and a gate of the third switch FET5A are respectively connected to the final-stage connection node WA4 of the first charge pump circuit 4, the output terminal 3, and the final-stage connection node WB4 of the second charge pump circuit 5. Due to this configuration, the third switch FET5A controls electrical connection between the final-stage connection node WA4 of the first charge pump circuit 4 and the output terminal 3, depending on the voltage of the final-stage connection node WB4 of the second charge pump circuit 5, i.e., the output voltage of the second charge pump circuit 5. Similarly, a source, a drain and a gate of the fourth switch FET5B are respectively connected to the final-stage connection node WB4 of the second charge pump circuit 5, the output terminal 3, and the final-stage connection node WA4 of the first charge pump circuit 4. Due to this configuration, the fourth switch FET5B controls electrical connection between the final-stage connection node WB4 of the second charge pump circuit 5 and the output terminal 3, depending on the voltage of the final-stage connection node WA4 of the first charge pump circuit 4, i.e., the output voltage of the first charge pump circuit 4.

A back gate and the source of the third switch FET5A is connected to the final-stage (fourth-stage) connection node WA4 of the first charge pump circuit 4. Similarly, a back gate and the source of the fourth switch FET5B is connected to the final-stage (fourth-stage) connection node WB4 of the second charge pump circuit 5.

When the voltage of the connection node WB4 is the High level, the output control circuit 7 outputs the voltage of the connection node WA4 as an output voltage VCPL. When the voltage of the connection node WA4 is the High level, the output control circuit 7 outputs the voltage of the connection node WB4 as the output voltage VCPL.

The first level shift circuits LS1A to LS4A and the second level shift circuits LS1B to LS4B form a control circuit 6 that controls switching operations of the first charge pump circuit 4 and the second charge pump circuit 5. More specifically, the first level shift circuits LS1A to LS4A respectively output gate control voltages to the gates of the first switches FET1A to FET4A to ON/OFF control the first switches FET1A to FET4A. The second level shift circuits LS1B to LS4B respectively output gate control voltages to the gates of the second switches FET1B to FET4B to ON/OFF control the second switches FET1B to FET4B. Here, an input voltage VA supplied to the first-stage first level shift circuit LS1A is the inverted signal of the input signal φA. An input voltage VB supplied to the first-stage second level shift circuit LS1B is the inverted signal of the input signal φB.

The first level shift circuits LS1A to LS4A and the second level shift circuits LS1B to LS4B each is a level shift circuit that performs level-shifting and outputs an inverted level of the input voltage level. For example, an inverter circuit shown in FIG. 7 is used as the level shift circuit in the present embodiment. More specifically, the inverter circuit has a PMOSFET 10, an NMOSFET 20, a first (positive-side) power supply terminal 11 and a second (negative-side) power supply terminal 12. The PMOSFET 10 and the NMOSFET 20 are series-connected between the first power supply terminal 11 and the second power supply terminal 12. A gate, a source and a drain of the PMOSFET 10 is connected to an input terminal IN, the first power supply terminal 11 and an output terminal OUT. A gate, a source and a drain of the NMOSFET 20 is connected to the input terminal IN, the second power supply terminal 12 and the output terminal OUT. When a gate-source voltage (i.e. a difference between a positive-side power supply voltage supplied to the first power supply terminal 11 and an input voltage supplied to the input terminal IN) of the PMOSFET 10 exceeds its threshold voltage, the PMOSFET 10 is turned ON and the positive-side power supply voltage is output from the output terminal OUT. When a gate-source voltage (i.e. a difference between a negative-side power supply voltage supplied to the second power supply terminal 12 and an input voltage supplied to the input terminal IN) of the NMOSFET 20 exceeds its threshold voltage, the NMOSFET 20 is turned ON and the negative-side power supply voltage is output from the output terminal OUT.

The first level shift circuits LS1A to LS4A respectively output the gate control voltages from the output terminals OUT to the gates of the first switches FET1A to FET4A to ON/OFF control the first switches FET1A to FET4A. The second level shift circuits LS1B to LS4B respectively output the gate control voltages from the output terminals OUT to the gates of the second switches FET1B to FET4B to ON/OFF control the second switches FET1B to FET4B.

First, the first level shift circuit LS1A and the second level shift circuit LS1B of the first-stage in the control circuit 6 will be described in detail. The first power supply terminal 11 of the first level shift circuit LS1A is connected to the input terminal 1 and is supplied with the input signal φA. The second power supply terminal 12 of the first level shift circuit LS1A is connected to the connection node WA1 and is supplied with the output voltage of the first-stage in the first charge pump circuit 4. The input terminal IN of the first level shift circuit LS1A is supplied with the input voltage VA. The first level shift circuit LS1A determines a gate control voltage VGA1 input to the gate of the first-stage first switch FET1A, depending on the input voltage VA and the input signal φA. On the other hand, the first power supply terminal 11 of the second level shift circuit LS1B is connected to the input terminal 2 and is supplied with the input signal φB. The second power supply terminal 12 of the second level shift circuit LS1B is connected to the connection node WB1 and is supplied with the output voltage of the first-stage in the second charge pump circuit 5. The input terminal IN of the second level shift circuit LS1B is supplied with the input voltage VB. The second level shift circuit LS1B determines a gate control voltage VGB1 input to the gate of the first-stage second switch FET1B, depending on the input voltage VB and the input signal φB.

Next, the first level shift circuit LS2A and the second level shift circuit LS2B of the second-stage in the control circuit 6 will be described in detail. The first power supply terminal 11 of the first level shift circuit LS2A is connected to the connection node WB1 of the second charge pump circuit 5 and is supplied with the output voltage of the first-stage in the second charge pump circuit 5. The second power supply terminal 12 of the first level shift circuit LS2A is connected to the connection node WA2 and is supplied with the output voltage of the second-stage in the first charge pump circuit 4. The input terminal IN of the first level shift circuit LS2A is connected to the connection node WA1 and is supplied with the output voltage of the first-stage in the first charge pump circuit 4. The first level shift circuit LS2A determines a gate control voltage VGA2 input to the gate of the second-stage first switch FET2A, depending on the output voltages of the first-stages in the first charge pump circuit 4 and the second charge pump circuit 5. On the other hand, the first power supply terminal 11 of the second level shift circuit LS2B is connected to the connection node WA1 of the first charge pump circuit 4 and is supplied with the output voltage of the first-stage in the first charge pump circuit 4. The second power supply terminal 12 of the second level shift circuit LS2B is connected to the connection node WB2 and is supplied with the output voltage of the second-stage in the second charge pump circuit 5. The input terminal IN of the second level shift circuit LS2B is connected to the connection node WB1 and is supplied with the output voltage of the first-stage in the second charge pump circuit 5. The second level shift circuit LS2B determines a gate control voltage VGB2 input to the gate of the second-stage second switch FET2B, depending on the output voltages of the first-stages in the first charge pump circuit 4 and the second charge pump circuit 5.

Next, the first level shift circuit LS3A and the second level shift circuit LS3B of the third-stage in the control circuit 6 will be described in detail. The first power supply terminal 11 of the first level shift circuit LS3A is connected to the connection node WB2 of the second charge pump circuit 5 and is supplied with the output voltage of the second-stage in the second charge pump circuit 5. The second power supply terminal 12 of the first level shift circuit LS3A is connected to the connection node WA3 and is supplied with the output voltage of the third-stage in the first charge pump circuit 4. The input terminal IN of the first level shift circuit LS3A is connected to the connection node WA2 and is supplied with the output voltage of the second-stage in the first charge pump circuit 4. The first level shift circuit LS3A determines a gate control voltage VGA3 input to the gate of the third-stage first switch FET3A, depending on the output voltages of the second-stages in the first charge pump circuit 4 and the second charge pump circuit 5. On the other hand, the first power supply terminal 11 of the second level shift circuit LS3B is connected to the connection node WA2 of the first charge pump circuit 4 and is supplied with the output voltage of the second-stage in the first charge pump circuit 4. The second power supply terminal 12 of the second level shift circuit LS3B is connected to the connection node WB3 and is supplied with the output voltage of the third-stage in the second charge pump circuit 5. The input terminal IN of the second level shift circuit LS3B is connected to the connection node WB2 and is supplied with the output voltage of the second-stage in the second charge pump circuit 5. The second level shift circuit LS3B determines a gate control voltage VGB3 input to the gate of the third-stage second switch FET3B, depending on the output voltages of the second-stages in the first charge pump circuit 4 and the second charge pump circuit 5.

Next, the first level shift circuit LS4A and the second level shift circuit LS4B of the fourth-stage in the control circuit 6 will be described in detail. The first power supply terminal 11 of the first level shift circuit LS4A is connected to the connection node WB3 of the second charge pump circuit 5 and is supplied with the output voltage of the third-stage in the second charge pump circuit 5. The second power supply terminal 12 of the first level shift circuit LS4A is connected to the connection node WA4 and is supplied with the output voltage of the fourth-stage in the first charge pump circuit 4. The input terminal IN of the first level shift circuit LS4A is connected to the connection node WA3 and is supplied with the output voltage of the third-stage in the first charge pump circuit 4. The first level shift circuit LS4A determines a gate control voltage VGA4 input to the gate of the fourth-stage first switch FET4A, depending on the output voltages of the third-stages in the first charge pump circuit 4 and the second charge pump circuit 5. On the other hand, the first power supply terminal 11 of the second level shift circuit LS4B is connected to the connection node WA3 of the first charge pump circuit 4 and is supplied with the output voltage of the third-stage in the first charge pump circuit 4. The second power supply terminal 12 of the second level shift circuit LS4B is connected to the connection node WB4 and is supplied with the output voltage of the fourth-stage in the second charge pump circuit 5. The input terminal IN of the second level shift circuit LS4B is connected to the connection node WB3 and is supplied with the output voltage of the third-stage in the second charge pump circuit 5. The second level shift circuit LS4B determines a gate control voltage VGB4 input to the gate of the fourth-stage second switch FET4B, depending on the output voltages of the third-stages in the first charge pump circuit 4 and the second charge pump circuit 5.

Due to the above-mentioned configuration, the charge pump circuit according to the present embodiment charges the even-numbered stage capacitors and the odd-numbered stage capacitors alternately in response to the input signals φA and φB (“VDD”=High level, “0 V”=Low level). In a stable period, the first-stage capacitors C1A and C1B each is charged with the voltage “VDD”. The other-stage capacitors each is charged with the voltage “2VDD”.

(Operation)

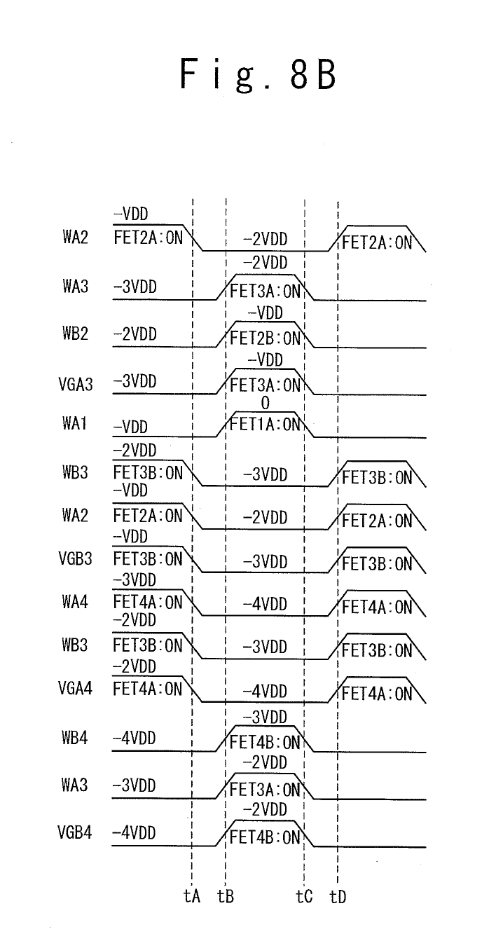

An operation of the charge pump circuit according to the present embodiment will be described in detail with reference to FIGS. 6, 8A and 8B. With regard to the input signals φA and φB, the voltage value “VDD” corresponds to the High level and the voltage value “0 V (GND)” corresponds to the Low level. For simplicity, let us consider a case where no voltage drop occurs in each FET switch when turned ON.

FIGS. 8A and 8B each is a timing chart showing an example of an operation (step down operation) of the charge pump circuit according to the present embodiment. In FIGS. 8A and 8B, the timings tA, tB, tC and tD are in chronological order. In a period (t<tA, tD<t), the input signal φA and the input voltage VB are at the Low level, and the input signal φB and the input voltage VA are at the High level. In a period (tB<t<tC), the input signal φA and the input voltage VB are at the High level, and the input signal φB and the input voltage VA are at the Low level. In a transition period (tA<t<tB, tC<t<tD), the input signals φA and φB both are at the Low level (0V).

The operation of the first-stage in the charge pump circuit according to the present embodiment will be described below.

First, the operation of the first-stage in the first charge pump circuit 4 and the control circuit 6 will be described.

In the period (tB<t<tC) in which the input signal φA is at the High level and the input signal φB is at the Low level, the input voltage VA is at the Low level “GND”. At this time, “VDD” is supplied to the power supply terminal 11 of the level shift circuit LS1A from the input terminal 1, and “0 V” is supplied to the power supply terminal 12 thereof from the connection node WA1. Since the input voltage VA input to the level shift circuit LS1A is at the Low level, the output voltage VGA1 output from the level shift circuit LS1A is “VDD”. As a result, the switch FET1A is turned ON, and thus the capacitor C1A is charged through the switch FET1A. The charge voltage of the capacitor C1A is “VDD”.

On the other hand, in the period (t<tA, t>tD) in which the input signal φA is at the Low level and the input signal φB is at the High level, the input voltage VA is at the High level “VDD”. At this time, “0 V” is supplied to the power supply terminal 11 of the level shift circuit LS1A from the input terminal 1, and “−VDD” is supplied to the power supply terminal 12 thereof from the connection node WA1. Since the input voltage VA input to the level shift circuit LS1A is at the High level, the output voltage VGA1 output from the level shift circuit LS1A is the same as the voltage of the connection node WA1. As a result, the switch FET1A is turned OFF. Since the capacitor C1A has been charged with the voltage “VDD” and one end of the capacitor C1A is connected to the input terminal 1 (“0V”), the voltage of the connection node WA1 connected to the other end of the capacitor C1A becomes “−VDD”. That is, the output voltage of the first-stage in the first charge pump circuit 4 becomes “−VDD”.

In this manner, in the above-mentioned two states ((1) the input signal φA is at the High level and the input signal φB is at the Low level; and (2) the input signal φA is at the Low level and the input signal φB is at the High level), the voltages applied to the PMOSFET 10 and the NMOSFET 20 of the level shift circuit LS1A and the switch FET1A are prevented from exceeding “VDD”.

Next, the operation of the first-stage in the second charge pump circuit 5 and the control circuit 6 will be described.

In the period (tB<t<tC) in which the input signal φA is at the High level and the input signal φB is at the Low level, the input voltage VB is at the High level “VDD”. At this time, “0 V” is supplied to the power supply terminal 11 of the level shift circuit LS1B from the input terminal 2, and “−VDD” is supplied to the power supply terminal 12 thereof from the connection node WB1. Since the input voltage VB input to the level shift circuit LS1B is at the High level, the output voltage VGB1 output from the level shift circuit LS1B is the same as the voltage of the connection node WB1. As a result, the switch FET1B is turned OFF. Since the capacitor C1B has been charged with the voltage “VDD” and one end of the capacitor C1B is connected to the input terminal 2 (“0V”), the voltage of the connection node WB1 connected to the other end of the capacitor C1B becomes “−VDD”. That is, the output voltage of the first-stage in the second charge pump circuit 5 becomes “−VDD”.

On the other hand, in the period (t<tA, t>tD) in which the input signal φA is at the Low level and the input signal φB is at the High level, the input voltage VB is at the Low level “0 V”. At this time, “VDD” is supplied to the power supply terminal 11 of the level shift circuit LS1B from the input terminal 2, and “0 V” is supplied to the power supply terminal 12 thereof from the connection node WB1. Since the input voltage VB input to the level shift circuit LS1B is at the Low level, the output voltage VGB1 output from the level shift circuit LS1B is “VDD”. As a result, the switch FET1B is turned ON. The capacitor C1B is charged through the switch FET1B. The charge voltage of the capacitor C1B is “VDD”.

Since the voltages of the gate, the source and the back gate of the NMOSFET 20 of the level shift circuit LS1B are “0 V”, the NMOSFET 20 is turned OFF. On the other hand, the voltage of the gate of the PMOSFET 10 of the level shift circuit LS1B is “0 V” and the voltages of the source and the back gate thereof are “VDD”, the PMOSFET 10 is turned ON and thus the output voltage VGB1 becomes “VDD”. In this period (t<tA, t>tD), no through current flows in the level shift circuit LS1B.

In this manner, in the above-mentioned two states ((1) the input signal φA is at the High level and the input signal φB is at the Low level; and (2) the input signal φA is at the Low level and the input signal φB is at the High level), the voltages applied to the PMOSFET 10 and the NMOSFET 20 of the level shift circuit LS1B and the switch FET1B are prevented from exceeding “VDD”.

Next, the operation of the second-stage in the charge pump circuit according to the present embodiment will be described below.

First, the operation of the second-stage in the first charge pump circuit 4 and the control circuit 6 will be described.

In the period (tB<t<tC) in which the input signal φA is at the High level and the input signal φB is at the Low level, the connection node WA1 is at “0 V” and the connection node WB1 is at “−VDD” as mentioned above. At this time, “−VDD” is supplied to the power supply terminal 11 of the level shift circuit LS2A from the connection node WB1, and “−2VDD” is supplied to the power supply terminal 12 thereof from the connection node WA2. Since “0 V” is supplied as the input voltage to the level shift circuit LS2A from the connection node WA1, the output voltage VGA2 output from the level shift circuit LS2A is the same as the voltage of the connection node WA2. As a result, the switch FET2A is turned OFF. Since the capacitor C2A has been charged with the voltage “2VDD” and one end of the capacitor C2A is connected to the input terminal 2 (“0V”), the voltage of the connection node WA2 connected to the other end of the capacitor C2A becomes “−2VDD”. That is, the output voltage of the second-stage in the first charge pump circuit 4 becomes “−2VDD”.

As described above, with regard to the level shift circuit LS2A in the period (tB<t<tC) in which the input signal φA is at the High level and the input signal φB is at the Low level, the input voltage is “0 V”, the power supply voltages are “−VDD” and “−2VDD”, and the output voltage VGA2 is “−2VDD”. That is, the maximum voltage applied to the element of the level shift circuit LS2A is “2VDD”. With regard to the switch FET2A, the gate voltage is “−2VDD”, and the drain and the source thereof are respectively connected to the connection node WA1 (“0 V”) and the connection node WA2 (“−2VDD”). Therefore, the maximum voltage applied to the switch FET2A is “2VDD”.

On the other hand, in the period (t<tA, t>tD) in which the input signal φA is at the Low level and the input signal φB is at the High level, the connection node WA1 is at “−VDD” and the connection node WB1 is at “0 V” as mentioned above. At this time, “0 V” is supplied to the power supply terminal 11 of the level shift circuit LS2A from the connection node WB1, and “−VDD” is supplied to the power supply terminal 12 thereof from the connection node WA2. Since “−VDD” is supplied as the input voltage to the level shift circuit LS2A from the connection node WA1, the output voltage VGA2 output from the level shift circuit LS2A is the same as the voltage of the connection node WB1. As a result, the switch FET2A is turned ON. One end of the capacitor C2A is supplied with “VDD” from the input terminal 2, the other end (connection node WA2) thereof is supplied with “−VDD” through the switch FET2A. As a result, the capacitor C2A is charged with a voltage “2VDD”.

As described above, with regard to the level shift circuit LS2A in the period (t<tA, t>tD) in which the input signal φA is at the Low level and the input signal φB is at the High level, the input voltage is “−VDD”, the power supply voltages are “0 V” and “−VDD”, and the output voltage VGA2 is “0 V”. That is, the maximum voltage applied to the element of the level shift circuit LS2A is “VDD”. With regard to the switch FET2A, the gate voltage is “0 V”, and the drain and the source thereof are respectively connected to the connection node WA1 (“−VDD”) and the connection node WA2 (“−VDD”). Therefore, the maximum voltage applied to the switch FET2A is “VDD”.

Next, the operation of the second-stage in the second charge pump circuit 5 and the control circuit 6 will be described.

In the period (tB<t<tC) in which the input signal φA is at the High level and the input signal φB is at the Low level, the connection node WB1 is at “−VDD” and the connection node WA1 is at “0 V” as mentioned above. At this time, “0 V” is supplied to the power supply terminal 11 of the level shift circuit LS2B from the connection node WA1, and “−VDD” is supplied to the power supply terminal 12 thereof from the connection node WB2. Since “−VDD” is supplied as the input voltage to the level shift circuit LS2B from the connection node WB1, the output voltage VGB2 output from the level shift circuit LS2B is the same as the voltage of the connection node WA1. As a result, the switch FET2B is turned ON. One end of the capacitor C2B is supplied with “VDD” from the input terminal 1, the other end (connection node WB2) thereof is supplied with “−VDD” through the switch FET2B. As a result, the capacitor C2B is charged with a voltage “2VDD”.

As described above, with regard to the level shift circuit LS2B in the period (tB<t<tC) in which the input signal φA is at the High level and the input signal φB is at the Low level, the input voltage is “−VDD”, the power supply voltages are “0 V” and “−VDD”, and the output voltage VGB2 is “0 V”. That is, the maximum voltage applied to the element of the level shift circuit LS2B is “VDD”. With regard to the switch FET2B, the gate voltage is “0 V”, and the drain and the source thereof are respectively connected to the connection node WB1 (“−VDD”) and the connection node WB2 (“−VDD”). Therefore, the maximum voltage applied to the switch FET2B is “VDD”.

On the other hand, in the period (t<tA, t>tD) in which the input signal φA is at the Low level and the input signal φB is at the High level, the connection node WB1 is at “0 V” and the connection node WA1 is at “−VDD” as mentioned above. At this time, “−VDD” is supplied to the power supply terminal 11 of the level shift circuit LS2B from the connection node WA1, and “−2VDD” is supplied to the power supply terminal 12 thereof from the connection node WB2. Since “0 V” is supplied as the input voltage to the level shift circuit LS2B from the connection node WB1, the output voltage VGB2 output from the level shift circuit LS2B is the same as the voltage of the connection node WB2. As a result, the switch FET2B is turned OFF. Since the capacitor C2B has been charged with the voltage “2VDD” and one end of the capacitor C2B is connected to the input terminal 1 (“0V”), the voltage of the connection node WB2 connected to the other end of the capacitor C2B becomes “−2VDD”. That is, the output voltage of the second-stage in the second charge pump circuit 5 becomes “−2VDD”.

As described above, with regard to the level shift circuit LS2B in the period (t<tA, t>tD) in which the input signal φA is at the Low level and the input signal φB is at the High level, the input voltage is “0 V”, the power supply voltages are “−VDD” and “−2VDD”, and the output voltage VGB2 is “−2VDD”. That is, the maximum voltage applied to the element of the level shift circuit LS2B is “2VDD”. With regard to the switch FET2B, the gate voltage is “−2VDD”, and the drain and the source thereof are respectively connected to the connection node WB1 (“0 V”) and the connection node WB2 (“−2VDD”). Therefore, the maximum voltage applied to the switch FET2B is “2VDD”.

In this manner, the output voltage of the second-stage (the voltages at the connection nodes WA2 and WB2) of the charge pump circuit according to the present embodiment is boosted to “−2VDD”. At this time, the absolute value of the maximum voltage applied to the transistors in the switch and the level shift circuit in the second-stage is “2VDD”.

Next, the operation of the third-stage in the charge pump circuit according to the present embodiment will be described below.

First, the operation of the third-stage in the first charge pump circuit 4 and the control circuit 6 will be described.

In the period (tB<t<tC) in which the input signal φA is at the High level and the input signal φB is at the Low level, the connection node WA2 is at “−2VDD” and the connection node WB2 is at “−VDD” as mentioned above. At this time, “−VDD” is supplied to the power supply terminal 11 of the level shift circuit LS3A from the connection node WB2, and “−2VDD” is supplied to the power supply terminal 12 thereof from the connection node WA3. Since “−2VDD” is supplied as the input voltage to the level shift circuit LS3A from the connection node WA2, the output voltage VGA3 output from the level shift circuit LS3A is the same as the voltage of the connection node WB2. As a result, the switch FET3A is turned ON. One end of the capacitor C3A is supplied with “0 V” from the connection node WA1, the other end (connection node WA3) thereof is supplied with “−2VDD” through the switch FET3A. As a result, the capacitor C3A is charged with a voltage “2VDD”.

As described above, with regard to the level shift circuit LS3A in the period (tB<t<tC) in which the input signal φA is at the High level and the input signal φB is at the Low level, the input voltage is “−2VDD”, the power supply voltages are “−VDD” and “−2VDD”, and the output voltage VGA3 is “−VDD”. That is, the maximum voltage applied to the element of the level shift circuit LS3A is “VDD”. With regard to the switch FET3A, the gate voltage is “−VDD”, and the drain and the source thereof are respectively connected to the connection node WA2 (“−2VDD”) and the connection node WA3 (“−2VDD”). Therefore, the maximum voltage applied to the switch FET3A is “VDD”.

On the other hand, in the period (t<tA, t>tD) in which the input signal φA is at the Low level and the input signal φB is at the High level, the connection node WA2 is at “−VDD” and the connection node WB2 is at “−2VDD” as mentioned above. At this time, “−2VDD” is supplied to the power supply terminal 11 of the level shift circuit LS3A from the connection node WB2, and “−3VDD” is supplied to the power supply terminal 12 thereof from the connection node WA3. Since “−VDD” is supplied as the input voltage to the level shift circuit LS3A from the connection node WA2, the output voltage VGA3 output from the level shift circuit LS3A is the same as the voltage of the connection node WA3. As a result, the switch FET3A is turned OFF. Since the capacitor C3A has been charged with the voltage “2VDD” and one end of the capacitor C3A is connected to the connection node WA1 (“−VDD”), the voltage of the connection node WA3 connected to the other end of the capacitor C3A becomes “−3VDD”. That is, the output voltage of the third-stage in the first charge pump circuit 4 becomes “−3VDD”.

As described above, with regard to the level shift circuit LS3A in the period (t<tA, t>tD) in which the input signal φA is at the Low level and the input signal φB is at the High level, the input voltage is “−VDD”, the power supply voltages are “−2VDD” and “−3VDD”, and the output voltage VGA3 is “−3VDD”. That is, the maximum voltage applied to the element of the level shift circuit LS3A is “2VDD”. With regard to the switch FET3A, the gate voltage is “−3VDD”, and the drain and the source thereof are respectively connected to the connection node WA2 (“−VDD”) and the connection node WA3 (“−3VDD”). Therefore, the maximum voltage applied to the switch FET3A is “2VDD”.

Next, the operation of the third-stage in the second charge pump circuit 5 and the control circuit 6 will be described.

In the period (tB<t<tC) in which the input signal φA is at the High level and the input signal φB is at the Low level, the connection node WB2 is at “−VDD” and the connection node WA2 is at “−2VDD” as mentioned above. At this time, “−2VDD” is supplied to the power supply terminal 11 of the level shift circuit LS3B from the connection node WA2, and “−3VDD” is supplied to the power supply terminal 12 thereof from the connection node WB3. Since “−VDD” is supplied as the input voltage to the level shift circuit LS3B from the connection node WB2, the output voltage VGB3 output from the level shift circuit LS3B is the same as the voltage of the connection node WB3. As a result, the switch FET3B is turned OFF. Since the capacitor C3B has been charged with the voltage “2VDD” and one end of the capacitor C3B is connected to the connection node WB1 (“−VDD”), the voltage of the connection node WB3 connected to the other end of the capacitor C3B becomes “−3VDD”. That is, the output voltage of the third-stage in the second charge pump circuit 5 becomes “−3VDD”.

As described above, with regard to the level shift circuit LS3B in the period (tB<t<tC) in which the input signal φA is at the High level and the input signal φB is at the Low level, the input voltage is “−VDD”, the power supply voltages are “−2VDD” and “−3VDD”, and the output voltage VGB3 is “−3VDD”. That is, the maximum voltage applied to the element of the level shift circuit LS3B is “2VDD”. With regard to the switch FET3B, the gate voltage is “−3VDD”, and the drain and the source thereof are respectively connected to the connection node WB2 (“−VDD”) and the connection node WB3 (“−3VDD”). Therefore, the maximum voltage applied to the switch FET3B is “2VDD”.

On the other hand, in the period (t<tA, t>tD) in which the input signal φA is at the Low level and the input signal φB is at the High level, the connection node WB2 is at “−2VDD” and the connection node WA2 is at “−VDD” as mentioned above. At this time, “−VDD” is supplied to the power supply terminal 11 of the level shift circuit LS3B from the connection node WA2, and “−2VDD” is supplied to the power supply terminal 12 thereof from the connection node WB3. Since “−2VDD” is supplied as the input voltage to the level shift circuit LS3B from the connection node WB2, the output voltage VGB3 output from the level shift circuit LS3B is the same as the voltage of the connection node WA2. As a result, the switch FET3B is turned ON. One end of the capacitor C3B is supplied with “0 V” from the connection node WB1, and the other end (connection node WB3) thereof is supplied with “−2VDD” through the switch FET3B. As a result, the capacitor C3B is charged with a voltage “2VDD”.

As described above, with regard to the level shift circuit LS3B in the period (t<tA, t>tD) in which the input signal φA is at the Low level and the input signal φB is at the High level, the input voltage is “−2VDD”, the power supply voltages are “−VDD” and “−2VDD”, and the output voltage VGB3 is “−VDD”. That is, the maximum voltage applied to the element of the level shift circuit LS3B is “VDD”. With regard to the switch FET3B, the gate voltage is “−VDD”, and the drain and the source thereof are respectively connected to the connection node WB2 (“−2VDD”) and the connection node WB3 (“−2VDD”). Therefore, the maximum voltage applied to the switch FET3B is “VDD”.

In this manner, the output voltage of the third-stage (the voltages at the connection nodes WA3 and WB3) of the charge pump circuit according to the present embodiment is boosted to “−3VDD”. At this time, the absolute value of the maximum voltage applied to the transistors in the switch and the level shift circuit in the third-stage is “2VDD”.

Next, the operation of the fourth-stage (final-stage) in the charge pump circuit according to the present embodiment will be described below.

First, the operation of the fourth-stage in the first charge pump circuit 4 and the control circuit 6 will be described.

In the period (tB<t<tC) in which the input signal φA is at the High level and the input signal φB is at the Low level, the connection node WA3 is at “−2VDD” and the connection node WB3 is at “−3VDD” as mentioned above. At this time, “−3VDD” is supplied to the power supply terminal 11 of the level shift circuit LS4A from the connection node WB3, and “−4VDD” is supplied to the power supply terminal 12 thereof from the connection node WA4. Since “−2VDD” is supplied as the input voltage to the level shift circuit LS4A from the connection node WA3, the output voltage VGA4 output from the level shift circuit LS4A is the same as the voltage of the connection node WA4. As a result, the switch FET4A is turned OFF. Since the capacitor C4A has been charged with the voltage “2VDD” and one end of the capacitor C4A is connected to the connection node WA2 (“−2VDD”), the voltage of the connection node WA4 connected to the other end of the capacitor C4A becomes “−4VDD”. That is, the output voltage of the fourth-stage in the first charge pump circuit 4 becomes “−4VDD”.

As described above, with regard to the level shift circuit LS4A in the period (tB<t<tC) in which the input signal φA is at the High level and the input signal φB is at the Low level, the input voltage is “−2VDD”, the power supply voltages are “−3VDD” and “−4VDD”, and the output voltage VGA4 is “−4VDD”. That is, the maximum voltage applied to the element of the level shift circuit LS4A is “2VDD”. With regard to the switch FET4A, the gate voltage is “−4VDD”, and the drain and the source thereof are respectively connected to the connection node WA3 (“−2VDD”) and the connection node WA4 (“−4VDD”). Therefore, the maximum voltage applied to the switch FET4A is “2VDD”.

On the other hand, in the period (t<tA, t>tD) in which the input signal φA is at the Low level and the input signal φB is at the High level, the connection node WA3 is at “−3VDD” and the connection node WB3 is at “−2VDD” as mentioned above. At this time, “−2VDD” is supplied to the power supply terminal 11 of the level shift circuit LS4A from the connection node WB3, and “−3VDD” is supplied to the power supply terminal 12 thereof from the connection node WA4. Since “−3VDD” is supplied as the input voltage to the level shift circuit LS4A from the connection node WA3, the output voltage VGA4 output from the level shift circuit LS4A is the same as the voltage of the connection node WB3. As a result, the switch FET4A is turned ON. One end of the capacitor C4A is supplied with “−VDD” from the connection node WA2, the other end (connection node WA4) thereof is supplied with “−3VDD” through the switch FET4A. As a result, the capacitor C4A is charged with a voltage “2VDD”.

As described above, with regard to the level shift circuit LS4A in the period (t<tA, t>tD) in which the input signal φA is at the Low level and the input signal φB is at the High level, the input voltage is “−3VDD”, the power supply voltages are “−2VDD” and “−3VDD”, and the output voltage VGA4 is “−2VDD”. That is, the maximum voltage applied to the element of the level shift circuit LS4A is “VDD”. With regard to the switch FET4A, the gate voltage is “−2VDD”, and the drain and the source thereof are respectively connected to the connection node WA3 (“−3VDD”) and the connection node WA4 (“−3VDD”). Therefore, the maximum voltage applied to the switch FET4A is “VDD”.

Next, the operation of the fourth-stage in the second charge pump circuit 5 and the control circuit 6 will be described.

In the period (tB<t<tC) in which the input signal φA is at the High level and the input signal φB is at the Low level, the connection node WB3 is at “−3VDD” and the connection node WA3 is at “−2VDD” as mentioned above. At this time, “−2VDD” is supplied to the power supply terminal 11 of the level shift circuit LS4B from the connection node WA3, and “−3VDD” is supplied to the power supply terminal 12 thereof from the connection node WB4. Since “−3VDD” is supplied as the input voltage to the level shift circuit LS4B from the connection node WB3, the output voltage VGB4 output from the level shift circuit LS4B is the same as the voltage of the connection node WA3. As a result, the switch FET4B is turned ON. One end of the capacitor C4B is supplied with “−VDD” from the connection node WB2, and the other end (connection node WB4) thereof is supplied with “−3VDD” through the switch FET4B. As a result, the capacitor C4B is charged with a voltage “2VDD”.

As described above, with regard to the level shift circuit LS4B in the period (tB<t<tC) in which the input signal φA is at the High level and the input signal φB is at the Low level, the input voltage is “−3VDD”, the power supply voltages are “−2VDD” and “−3VDD”, and the output voltage VGB4 is “−2VDD”. That is, the maximum voltage applied to the element of the level shift circuit LS4B is “VDD”. With regard to the switch FET4B, the gate voltage is “−2VDD”, and the drain and the source thereof are respectively connected to the connection node WB3 (“−3VDD”) and the connection node WB4 (“−3VDD”). Therefore, the maximum voltage applied to the switch FET4B is “VDD”.

On the other hand, in the period (t<tA, t>tD) in which the input signal φA is at the Low level and the input signal φB is at the High level, the connection node WB3 is at “−2VDD” and the connection node WA3 is at “−3VDD” as mentioned above. At this time, “−3VDD” is supplied to the power supply terminal 11 of the level shift circuit LS4B from the connection node WA3, and “−4VDD” is supplied to the power supply terminal 12 thereof from the connection node WB4. Since “−2VDD” is supplied as the input voltage to the level shift circuit LS4B from the connection node WB3, the output voltage VGB4 output from the level shift circuit LS4B is the same as the voltage of the connection node WB4. As a result, the switch FET4B is turned OFF. Since the capacitor C4B has been charged with the voltage “2VDD” and one end of the capacitor C4B is connected to the connection node WB2 (“−2VDD”), the voltage of the connection node WB4 connected to the other end of the capacitor C4B becomes “−4VDD”. That is, the output voltage of the fourth-stage in the second Charge pump circuit 5 becomes “−4VDD”.

As described above, with regard to the level shift circuit LS4B in the period (t<tA, t>tD) in which the input signal φA is at the Low level and the input signal φB is at the High level, the input voltage is “−2VDD”, the power supply voltages are “−3VDD” and “−4VDD”, and the output voltage VGB4 is “−4VDD”. That is, the maximum voltage applied to the element of the level shift circuit LS4B is “2VDD”. With regard to the switch FET4B, the gate voltage is “−4VDD”, and the drain and the source thereof are respectively connected to the connection node WB3 (“−2VDD”) and the connection node WB4 (“−4VDD”). Therefore, the maximum voltage applied to the switch FET4B is “2VDD”.

In this manner, the output voltage of the fourth-stage (the voltages at the connection nodes WA4 and WB4) of the charge pump circuit according to the present embodiment is boosted to “−4VDD”. At this time, the absolute value of the maximum voltage applied to the transistors in the switch and the level shift circuit in the fourth-stage is “2VDD”.

Meanwhile, in the period (tB<t<tC) in which the input signal φA is at the High level and the input signal φB is at the Low level, the gate voltage of the switch FET5A (i.e. the voltage of the connection node WB4) is “−3VDD” and the source voltage of the switch FET5A (i.e. the voltage of the connection node WA4) is “−4VDD”. On the other hand, the gate voltage of the switch FET5B (i.e. the voltage of the connection node WA4) is “−4VDD” and the source voltage of the switch FET5B (i.e. the voltage of the connection node WB4) is “−3VDD”. Therefore, the switch FET5A is turned ON while the switch FET5B is turned OFF. Consequently, in the period (tB<t<tC), the voltage “−4VDD” supplied from the connection node WA4 is output as the output voltage VCPL from the output terminal 3.

In the period (t<tA, t>tD) in which the input signal φA is at the Low level and the input signal φB is at the High level, the gate voltage of the switch FET5A (i.e. the voltage of the connection node WB4) is “−4VDD” and the source voltage of the switch FET5A (i.e. the voltage of the connection node WA4) is “−3VDD”. On the other hand, the gate voltage of the switch FET5B (i.e. the voltage of the connection node WA4) is “−3VDD” and the source voltage of the switch FET5B (i.e. the voltage of the connection node WB4) is −4VDD”. Therefore, the switch FET5A is turned OFF while the switch FET5B is turned ON. Consequently, in the period (t<tA, t>tD), the voltage “−4VDD” supplied from the connection node WB4 is output as the output voltage VCPL from the output terminal 3.

As described above, the charge pump circuit according to the present embodiment repeats the above-mentioned two states ((1) the input signal φA is at the High level and the input signal φB is at the Low level; and (2) the input signal φA is at the Low level and the input signal φB is at the High level) and can generate the output voltage VCPL of “−4VDD” with suppressing the maximum voltage applied to the internal transistors to at most “2VDD”. Although the four-stage charge pump circuit has been described as an example of the present embodiment, the present invention is not limited to that. By increasing the number of stages of the charge circuit, it is possible to further increase the output voltage VCPL depending on the number of stages, with maintaining the maximum voltage value applied to the internal transistors to at most “2VDD”. That is, it is possible according to the present invention to make the charge pump output voltage larger than the element breakdown voltage of the internal transistors, without increasing the element breakdown voltage of the internal transistors.

Moreover, since the maximum voltage applied to the internal transistors is suppressed to “2VDD”, the element breakdown voltage of the internal transistors of the charge pump circuit can be reduced. As a result, the circuit size of the charge pump circuit can be reduced.

Moreover, the switch transistor according to the present embodiment is ON/OFF controlled by the gate control voltage with which the maximum value of the gate-source voltage is suppressed to “2VDD”. Therefore, according to the charge pump circuit of the present embodiment, the boosting operation is possible by the gate control voltage smaller than the element breakdown voltage of the transistor.

Although the embodiment has been described above, a concrete configuration of the present invention is not limited to that of the above-described embodiment. For example, although the magnification ratio of the charge pump circuit is 4 in the above-described embodiment, it is not limited to that and can take another value. In any case, the charge pump circuit is provided with the number of stages depending on the magnification ratio and performs the boosting operation depending on the magnification ratio.

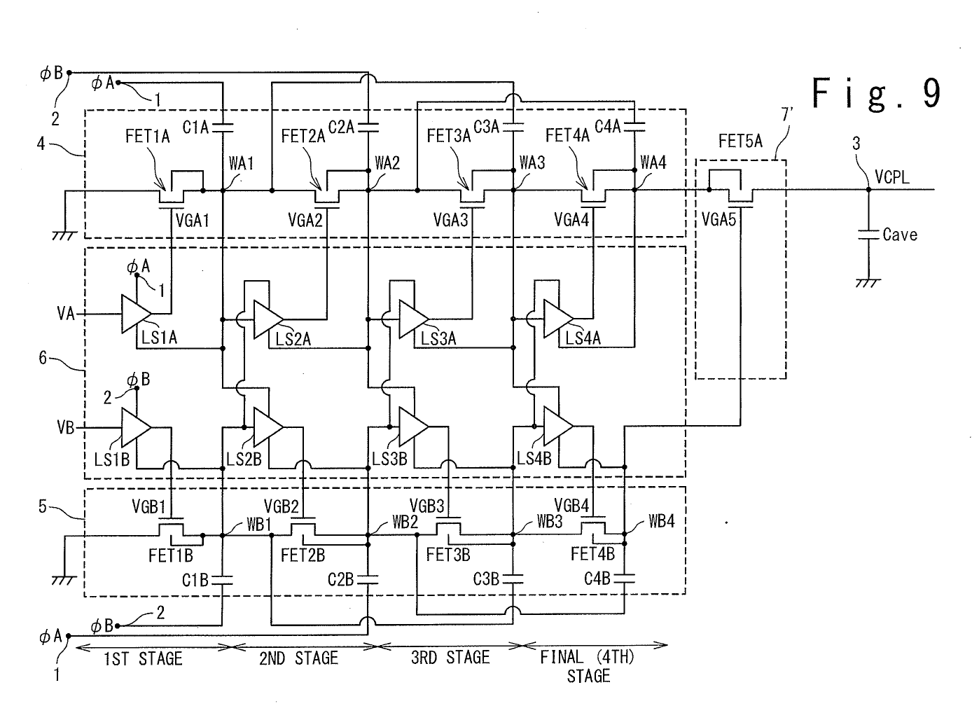

Moreover, the switch FET5B in the output control circuit 7 may be omitted as described below. FIG. 9 shows a modification example of the configuration of the charge pump circuit according to the present embodiment. The charge pump circuit shown in FIG. 9 is provided with an output control circuit 7′ that is obtained by removing the switch FET5B from the output control circuit 7 shown in FIG. 6. The switch FET5A controls electrical connection between the connection node WA4 and the output terminal 3 depending on the voltage supplied from the connection node WB4. The other configuration is the same as in the case of the charge pump circuit shown in FIG. 6.

The path of the second charge pump circuit 5 in the present modification example is used for generating the first power supply voltages supplied to the level shifter circuits LS1A to LS4A that generate the gate control signals for the first charge pump circuit 4.

In the period (tB<t<tC) in which the input signal φA is at the High level and the input signal φB is at the Low level, the gate voltage of the switch FET5A (i.e. the voltage of the connection node WB4) is “−3VDD” and the source voltage of the switch FET5A (i.e. the voltage of the connection node WA4) is “−4VDD”. Therefore, the switch FET5A is turned ON. Consequently, in the period (tB<t<tC), the voltage “−4VDD” supplied from the connection node WA4 is output as the output voltage VCPL from the output terminal 3.

According to the charge pump circuit shown in FIG. 9, it is possible to minimize the sizes of the switches FET1B to FET4B, the level shift circuits LS1B to LS4B and the capacitors C1B to C4B. Moreover, by adjusting the element sizes, the boosting operation timing of the switches FET1A to FET4A can be adjusted appropriately.

It should be noted that the present invention is not limited to the negative voltage charge pump circuit as in the case of the above-described embodiment and modification example. The same applies to the positive voltage charge pump circuit. That is, the present invention can also achieve the positive voltage charge pump circuit.

It is apparent that the present invention is not limited to the above embodiments and may be modified and changed without departing from the scope and spirit of the invention.

What is claimed is:

1. A charge pump circuit comprising:
a first charge pump circuit and a second charge pump circuit that alternately perform boosting operations; and
a control circuit configured to control the respective boosting operations of said first charge pump circuit and said second charge pump circuit,
wherein said first charge pump circuit comprises:
plural stages of first switch transistors that are series-connected one after another;
plural stages of first connection nodes that are respectively connected to sources of said plural stages of first switch transistors; and
plural stages of first capacitors whose one ends are respectively connected to said plural stages of first connection nodes,
wherein said second charge pump circuit comprises:
plural stages of second switch transistors that are series-connected one after another;
plural stages of second connection nodes that are respectively connected to sources of said plural stages of second switch transistors; and
plural stages of second capacitors whose one ends are respectively connected to said plural stages of second connection nodes,
wherein said control circuit comprises:
plural stages of first inverters; and
plural stages of second inverters,
wherein n is an integer equal to or more than 3,
wherein the n-th-stage first inverter of said plural stages of first inverters is configured to be supplied with a positive-side power supply voltage from the (n−1)-th-stage second connection node of said plural stages of second connection nodes, to be supplied with a negative-side power supply voltage from the n-th-stage first connection node of said plural stages of first connection nodes, to be supplied with an input voltage from the (n−1)-th-stage first connection node of said plural stages of first connection nodes, and to output an output voltage to a gate of the n-th-stage first switch transistor of said plural stages of first switch transistors, and
wherein the n-th-stage second inverter of said plural stages of second inverters is configured to be supplied with a positive-side power supply voltage from the (n−1)-th-stage first connection node of said plural stages of first connection nodes, to be supplied with a negative-side power supply voltage from the n-th-stage second connection node of said plural stages of second connection nodes, to be supplied with an input voltage from the (n−1)-th-stage second connection node of said plural stages of second connection nodes, and to output an output voltage to a gate of the n-th-stage second switch transistor of said plural stages of second switch transistors.

2. The charge pump circuit according to claim 1,
wherein the one end of the n-th-stage first capacitor of said plural stages of first capacitors is connected to the n-th-stage first connection node of said plural stages of first connection nodes, and the other end thereof is connected to the (n−2)-th-stage first connection node of said plural stages of first connection nodes, and
wherein the one end of the n-th-stage second capacitor of said plural stages of second capacitors is connected to the n-th-stage second connection node of said plural stages of second connection nodes, and the other end thereof is connected to the (n−2)-th-stage second connection node of said plural stages of second connection nodes.

3. The charge pump circuit according to claim 2,
wherein the one end of the first-stage first capacitor of said plural stages of first capacitors is connected to the first-stage first connection node of said plural stages of first connection nodes, and the other end thereof is connected to a first input terminal to which a first input signal is supplied,
wherein the one end of the second-stage first capacitor of said plural stages of first capacitors is connected to the second-stage first connection node of said plural stages of first connection nodes, and the other end thereof is connected to a second input terminal to which a second input signal is supplied,
wherein a level of said first input signal and said second input signal each is switched between a high level and a low level, said first input signal is at the low level when said second input signal is at the high level, and said second input signal is at the low level when said first input signal is at the high level,
wherein the one end of the first-stage second capacitor of said plural stages of second capacitors is connected to the first-stage second connection node of said plural stages of second connection nodes, and the other end thereof is connected to said second input terminal, and
wherein the one end of the second-stage second capacitor of said plural stages of second capacitors is connected to the second-stage second connection node of said plural stages of second connection nodes, and the other end thereof is connected to said first input terminal.

4. The charge pump circuit according to claim 3,
wherein the first-stage first inverter of said plural stages of first inverters is configured to be supplied with a positive-side power supply voltage from said first input terminal, to be supplied with a negative-side power supply voltage from the first-stage first connection node of said plural stages of first connection nodes, to be supplied with an input signal being an inverted signal of said first input signal, and to output an output voltage to a gate of the first-stage first switch transistor of said plural stages of first switch transistors,
wherein the first-stage second inverter of said plural stages of second inverters is configured to be supplied with a positive-side power supply voltage from said second input terminal, to be supplied with a negative-side power supply voltage from the first-stage second connection node of said plural stages of second connection nodes, to be supplied with an input signal being an inverted signal of said second input signal, and to output an output voltage to a gate of the first-stage second switch transistor of said plural stages of second switch transistors,
wherein the second-stage first inverter of said plural stages of first inverters is configured to be supplied with a positive-side power supply voltage from the first-stage second connection node of said plural stages of second connection nodes, to be supplied with a negative-side power supply voltage from the second-stage first connection node of said plural stages of first connection nodes, to be supplied with an input voltage from the first-stage first connection node of said plural stages of first connection nodes, and to output an output voltage to a gate of the second-stage first switch transistor of said plural stages of first switch transistors, and
wherein the second-stage second inverter of said plural stages of second inverters is configured to be supplied with a positive-side power supply voltage from the first-stage first connection node of said plural stages of first connection nodes, to be supplied with a negative-side power supply voltage from the second-stage second connection node of said plural stages of second connection nodes, to be supplied with an input voltage from the first-stage second connection node of said plural stages of second connection nodes, and to output an output voltage to a gate of the second-stage second switch transistor of said plural stages of second switch transistors.

5. The charge pump circuit claim 1, further comprising an output control circuit connected to the final-stage first connection node of said plural stages of first connection nodes and the final-stage second connection node of said plural stages of second connection nodes.

6. The charge pump circuit according to claim 5,
wherein said output control circuit comprises a third switch transistor configured to control electrical connection between said final-stage first connection node and an output terminal depending on a voltage of said final-stage second connection node.

7. The charge pump circuit according to claim 6,
wherein said output control circuit further comprises a fourth switch transistor configured to control electrical connection between said final-stage second connection node and said output terminal depending on a voltage of said final-stage first connection node.
